(19) United States
(12) Patent Application Publication
(10) Pub. No.: US 2007/0298299 A1
(43) Pub. Date: Dec. 27, 2007

(54) Fuel Cell

(75) Inventors: Yasuhiro Izawa, Shizuoka-ken (JP); Naoki Ito, Kanagawa-ken (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 10/581,892

(22) PCT Filed: Dec. 16, 2004
(86) PCT No.: PCT/JP04/19293

§ 371 Date: Jun. 6, 2006

(30) Foreign Application Priority Data
Dec. 24, 2003 (JP) 2003-427083

(51) Int. Cl. H01M 8/04

(52) U.S. Cl. 429/26

(57) ABSTRACT

A fuel cell of the invention has a hydrogen permeable metal layer, which is formed on a plane of an electrolyte layer that has proton conductivity and includes a hydrogen permeable metal. The amount of a catalyst supported on a catalyst layer in the fuel cell is regulated according to an uneven temperature distribution in the fuel cell, which is caused by operating conditions of the fuel cell including temperatures and flow directions of fluids supplied to the fuel cell. Such regulation effectively equalizes an uneven temperature distribution in the fuel cell and thus advantageously prevents the lowered durability and the deteriorating performance of the fuel cell due to the uneven temperature distribution in the fuel cell having the hydrogen permeable metal layer.

### TECHNICAL FIELD

The present invention relates to a fuel cell, and more specifically pertains to a fuel cell including an electrolyte layer and a hydrogen permeable metal layer.

### BACKGROUND ART

Various types of fuel cells have been proposed. For example, a known fuel cell has a hydrogen permeable palladium metal membrane formed as the anode structure on a proton conductive electrolyte layer. In this prior art fuel cell, the metal membrane formed as the anode structure on the electrolyte layer has hydrogen permeability and thus enables even a reformed gas of a relatively low purity to be supplied directly as the fuel gas to the anode.

The metal material of the hydrogen permeable metal layer generally has a large coefficient of thermal expansion and significantly varies the expansion rate with a variation in temperature. An uneven temperature distribution in the hydrogen permeable metal layer accordingly causes different expansion rates in respective sites of the hydrogen permeable metal layer. This deteriorates the hydrogen permeable metal layer and undesirably lowers the durability of the hydrogen permeable metal layer. The uneven temperature distribution in the fuel cell may also deteriorate the performance of the fuel cell. In order to maintain the sufficiently high performance of the fuel cell, it is accordingly demanded to equalize the temperature distribution in the fuel cell and keep the operating temperature of the whole fuel cell in a predetermined temperature range.

### DISCLOSURE OF THE INVENTION

The object of the invention is thus to eliminate the drawbacks of the prior art technique and to prevent the lowered durability and the deteriorating performance of fuel cells, due to an uneven temperature distribution in the fuel cells having hydrogen permeable metal layers.

In order to attain at least part of the above and the other related objects, the present invention is directed to a fuel cell having a hydrogen permeable metal layer that is formed on a plane of an electrolyte layer that has proton conductivity and includes a hydrogen permeable metal. The fuel cell includes a temperature distribution equalizing portion to equalize an uneven temperature distribution in the fuel cell, which is caused by either or both of operating conditions of the fuel cell and surroundings of the fuel cell.

The fuel cell of the invention having the above structure equalizes the uneven temperature distribution in the fuel cell, which is caused by either or both of operating conditions of the fuel cell and surroundings of the fuel cell. This arrangement effectively prevents the lowered durability of the hydrogen permeable metal layer and the deteriorating performance of the fuel cell, due to the uneven temperature distribution in the fuel cell.

In one preferable aspect of the fuel cell of the invention, the temperature distribution equalizing portion controls heat generation in a higher temperature area having a higher temperature than a residual area, due to either or both of the operating conditions of the fuel cell and the surroundings of the fuel cell.

This arrangement reduces heat generation in the higher temperature area having the higher temperature than the residual area, thus effectively equalizing the uneven temperature distribution in the fuel cell.

In the fuel cell of the invention, it is preferable that the temperature distribution equalizing portion suppresses an electrochemical reaction in the higher temperature area.

The electrochemical reaction generates heat in the fuel cell. Suppression of the electrochemical reaction thus reduces heat generation and equalizes the uneven temperature distribution in the fuel cell.

In one preferable aspect of the fuel cell of the invention, the temperature distribution equalizing portion is a catalyst layer that contains a catalyst of accelerating the electrochemical reaction and is formed on an electrode of the fuel cell to have a less content of the catalyst in a specific region corresponding to the higher temperature area than a content of the catalyst in a residual region corresponding to the residual area.

This arrangement suppresses the electrochemical reaction in the specific region of the catalyst layer having the less content of the catalyst, thus equalizing the uneven temperature distribution in the fuel cell.

In another preferable aspect of the fuel cell of the invention, the temperature distribution equalizing portion is an electrode that is a thin metal membrane having the electrochemical reaction and is designed to have a smaller surface area in a specific region corresponding to the higher temperature area.

This arrangement suppresses the electrochemical reaction in the specific region having the smaller surface area of the electrode, thus equalizing the uneven temperature distribution in the fuel cell.

In the fuel cell of this structure, the electrode may be the hydrogen permeable metal layer. The hydrogen permeable metal layer functioning as an electrode is designed to have the smaller surface area in the specific region corresponding to the higher temperature area. This arrangement effectively equalizes the uneven temperature distribution in the fuel cell.

In the fuel cell of the invention, the temperature distribution equalizing portion may be the hydrogen permeable metal layer that is designed to have a greater thickness in a specific region corresponding to the higher temperature area.

This arrangement suppresses the electrochemical reaction in the specific region having the greater thickness of the hydrogen permeable metal layer, thus equalizing the uneven temperature distribution in the fuel cell.

In the fuel cell of the invention, it is preferable that a reformed gas prepared by reforming a hydrocarbon fuel is used as a fuel gas supplied to an anode of the fuel cell.

The reformed gas obtained by reforming a hydrocarbon fuel generally has a higher temperature than the hydrogen gas stored in a hydrogen tank. The reformed gas used as the fuel gas tends to excessively raise the temperature in a specific area of the fuel cell and cause an uneven temperature distribution, compared with the lower-temperature hydrogen gas. The technique of the invention is thus effectively applicable to the structure of using the reformed gas as the fuel gas to equalize the temperature distribution in the fuel cell and thereby effectively prevent the lowered durability and the deteriorating performance of the fuel cell.

In one preferable aspect of the fuel cell of the invention, the temperature distribution equalizing portion includes a reforming catalyst portion, which is formed to be in contact with an anode inside the fuel cell and contains a reforming catalyst of accelerating a reforming reaction to produce hydrogen from a hydrocarbon fuel. The reforming catalyst portion receives supplies of the hydrocarbon fuel and steam and has a greater content of the reforming catalyst in a specific region corresponding to the higher temperature area than a content of the reforming catalyst in a residual region corresponding to the residual area.

The reforming catalyst accelerates the endothermic reforming reaction. A temperature rise is thus more effectively restrained in the specific region having the greater content of the reforming catalyst in the reforming catalyst portion. This arrangement effectively interferes with a temperature rise in the specific region having the higher temperature than the residual region and thereby equalizes the uneven temperature distribution in the fuel cell.

In another preferable aspect of the fuel cell of the invention, the temperature distribution equalizing portion includes a shift catalyst portion, which is formed to be in contact with an anode inside the fuel cell and contains a shift catalyst of accelerating a shift reaction to produce hydrogen and carbon dioxide from carbon monoxide and steam. The shift catalyst portion receives a supply of a reformed gas containing hydrogen, carbon monoxide, and steam and has a greater content of the shift catalyst in a specific region corresponding to a lower temperature area, which has a lower temperature than a remaining area due to either or both of the operating conditions of the fuel cell and the surroundings of the fuel cell, than a content of the shift catalyst in a residual region corresponding to the remaining area.

The shift catalyst accelerates the exothermic shift reaction. A temperature rise is accordingly accelerated in the specific region having the greater content of the shift catalyst in the shift catalyst portion. This arrangement effectively prevents a temperature drop in the specific region having the lower temperature than the residual region and thereby equalizes the uneven temperature distribution in the fuel cell.

In one preferable aspect of the invention, the temperature distribution equalizing portion is provided to deal with an uneven temperature distribution on an identical plane of the fuel cell as a unit cell of a fuel cell stack, which is caused by either or both of the operating conditions of the fuel cell and the surroundings of the fuel cell.

This structure effectively equalizes the uneven temperature distribution in an identical plane of the fuel cell as the unit cell of the fuel cell stack.

In another preferable aspect of the invention, a number of the fuel cells as unit cells are laminated to form a fuel cell stack, and the temperature distribution equalizing portion is provided to deal with a total uneven temperature distribution in the whole fuel cell stack, which is caused by either or both of the operating conditions of the fuel cells and the surroundings of the fuel cells.

This structure effectively equalizes the uneven temperature distribution in the whole stack of fuel cells.

The invention is further directed to a first fuel cell device including a fuel cell, where the fuel cell has a hydrogen permeable metal layer, which is formed on a plane of an electrolyte layer that has proton conductivity and includes a hydrogen permeable metal. The first fuel cell device has a temperature distribution equalizing portion to control an uneven temperature distribution in the fuel cells, due to temperature and flow direction of a reactive gas supplied to the fuel cells to be subjected to an electrochemical reaction. The temperature distribution equalizing portion includes: a first flow path and a second flow path to supply and discharge the reactive gas into and from the fuel cells; a first switchover element that is provided in the first flow path to make a switchover between a gas intake state of allowing the reactive gas to be fed from a conduit connecting with the first flow path and to be introduced into the fuel cells and a gas discharge state of connecting the first flow path with outside to discharge the reactive gas flowed through the fuel cells to the outside; and a second switchover element that is provided in the second flow path to make a switchover between the gas intake state of allowing the reactive gas to be fed from a conduit connecting with the second flow path and to be introduced into the fuel cells and the gas discharge state of connecting the second flow path with the outside to discharge the reactive gas flowed through the fuel cells to the outside. The first switchover element and the second switchover element are controlled to regulate the flow direction of the reactive gas passing through the fuel cells.

The first fuel cell device of the invention changes the flow direction of the reactive gas to switch over the higher temperature area and the lower temperature area. Such switchover restrains an excessive temperature rise or temperature drop in a specific area, thus equalizing the temperature distribution in the fuel cells. This arrangement desirably interferes with an uneven temperature distribution in the fuel cells caused by the temperature and the flow direction of the reactive gas supplied to the fuel cells and thus effectively prevents the lowered durability of the hydrogen permeable metal layers and the deteriorating performance of the fuel cells due to an uneven temperature distribution in the fuel cells.

The present invention is also directed to a second fuel cell device including a fuel cell, where the fuel cell has a hydrogen permeable metal layer, which is formed on a plane of an electrolyte layer that has proton conductivity and includes a hydrogen permeable metal. The second fuel cell device has a temperature distribution equalizing portion to control an uneven temperature distribution in the fuel cells, due to either or both of temperature and flow direction of a reactive gas supplied to the fuel cells to be subjected to an electrochemical reaction and surroundings of the fuel cells. The temperature distribution equalizing portion includes: a reactive gas circulation module that recirculates at least part of a reactive gas exhaust, which is the reactive gas flowed through and discharged from the fuel cells, to the flow of the reactive gas; and a reactive gas temperature decreasing module that decreases temperature of the reactive gas exhaust, prior to recirculation of the reactive gas exhaust to the flow of the reactive gas.

The second fuel cell device of the invention lowers the temperature of the reactive gas flowed into the fuel cells and accordingly interferes with a potential temperature rise in a specific area of the fuel cells caused by the temperature and the flow direction of the reactive gas and/of the surrounding of the fuel cells. This arrangement desirably restrains an uneven temperature distribution in the fuel cells and thus effectively prevents the lowered durability of the hydrogen permeable metal layers and the deteriorating performance of the fuel cells.

The technique of the invention is not restricted to the fuel cell having any of the above structures or to the fuel cell device having any of the above arrangements, but is also attained by diversity of other applications, for example, a power supply system including the fuel cells or the fuel cell device of the invention, as well as a moving body with the fuel cells of the invention mounted thereon as a driving energy source.

### BRIEF DESCRIPTION OF THE DRAWINGS

FIG. 1 is a sectional view schematically illustrating the structure of a unit fuel cell in a first embodiment of the invention;

FIG. 2 schematically shows the flows of fluids in one unit fuel cell 20 of the embodiment;

FIG. 3 shows a temperature distribution on one unit cell plane of a fuel cell stack;

FIG. 4 shows a variation in amount of catalyst supported on a catalyst layer and a temperature distribution in the presence of the catalyst layer;

FIG. 5 shows a temperature distribution on one unit cell plane in a stack of fuel cells in another example;

FIG. 6 shows a variation in content of the catalyst over a catalyst layer in the fuel cell in the example of FIG. 5;

FIG. 7 shows a temperature distribution on one unit cell plane in a stack of fuel cells in still another example;

FIG. 8 shows a variation in content of the catalyst over a catalyst layer in the fuel cell in the example of FIG. 7;

FIG. 9 shows a temperature distribution on one unit cell plane in a stack of fuel cells in another example;

FIG. 10 is a sectional view schematically illustrating the structure of a fuel cell in a second embodiment of the invention;

FIG. 11 shows a variation in surface area of a cathode in the fuel cell of the second embodiment;

FIG. 12 is a sectional view schematically illustrating the structure of a fuel cell in a third embodiment of the invention;

FIG. 13 is a sectional view schematically illustrating the structure of a fuel cell in a fourth embodiment of the invention;

FIG. 14 is a sectional view schematically illustrating the structure of another fuel cell including a hydrogen permeable metal layer having a varying internal structure in one example;

FIG. 15 is a sectional view schematically illustrating the structure of another fuel cell including a hydrogen permeable metal layer having a varying internal structure in another example;

FIG. 16 is a sectional view schematically illustrating the structure of another fuel cell including a hydrogen permeable metal layer having a varying internal structure in still another example;

FIG. 17 is a sectional view schematically illustrating the structure of another fuel cell including a hydrogen permeable metal layer having a varying internal structure in another example;

FIG. 18 shows the configuration of a fuel cell device in a fifth embodiment of the invention;

FIG. 19 shows the configuration of another fuel cell device in a sixth embodiment of the invention;

FIG. 20 shows a variation in amount of a reforming catalyst supported on a gas separator in a seventh embodiment of the invention;

FIG. 21 shows the layout of catalysts supported on the surface of a gas separator in an eighth embodiment of the invention; and

FIG. 22 shows a variation in amount of a shift catalyst supported on a gas separator in a ninth embodiment of the invention.

### BEST MODES OF CARRYING OUT THE INVENTION

Some modes of carrying out the invention are described below as preferred embodiments:

### A. Structure of Fuel Cell in First Embodiment

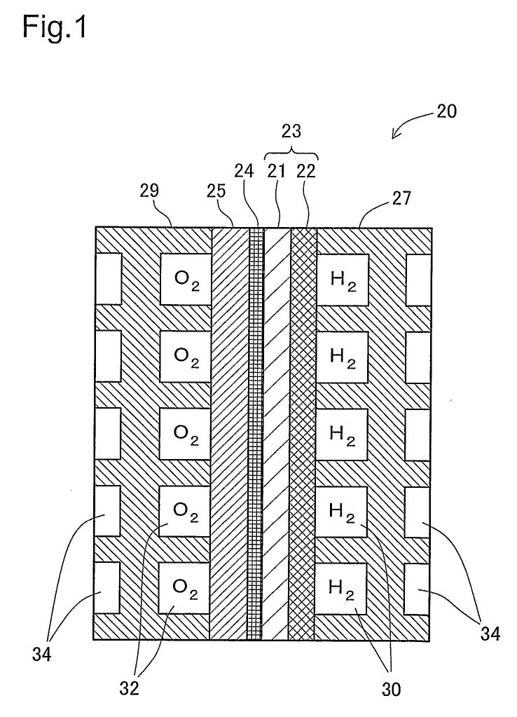

FIG. 1 is a sectional view schematically illustrating the structure of a unit fuel cell 20 as a unit of fuel cells in a first embodiment of the invention. The unit fuel cell 20 has an electrolyte module 23 including a hydrogen permeable metal layer 22 and an electrolyte layer 21, a catalyst layer 24 formed on the electrolyte layer 21, a cathode 25 formed on the catalyst layer 24, and a pair of gas separators 27 and 29 located across the assembly of this layered structure. In-cell fuel gas conduits 30 are defined by and formed between the gas separator 27 and the hydrogen permeable metal layer 22 to allow a flow of a hydrogen-containing fuel gas. Similarly, in-cell oxidizing gas conduits 32 are defined by and formed between the gas separator 29 and the cathode 25 to allow a flow of an oxygen-containing oxidizing gas. The fuel cells of the invention have a stack structure including a number of the unit fuel cells 20 shown in FIG. 1. Coolant conduits 34 for a flow of a coolant are formed between the adjacent gas separators 27 and 29 in each pair of adjoining unit cells 20.

The hydrogen permeable metal layer 22 is made of a metal having hydrogen permeability. The metal of the hydrogen permeable metal layer 22 may be, for example, palladium (Pd) or a Pd alloy. The hydrogen permeable metal layer 22 may otherwise be a multi-layered membrane including a base material layer of a group 5 metal like vanadium (V), niobium (Nb), or tantalum (Ta) or a group 5 metal-containing alloy and a Pd or Pd-containing alloy layer formed on at least one face of the base material layer (on the side of the in-cell fuel gas conduits 30).

The electrolyte layer 21 is made of a solid electrolyte having proton conductivity, for example, a ceramic proton conductor of BaCeO₃ or SrCeO₃. The electrolyte layer 21 is provided by depositing such a solid oxide on the hydrogen permeable metal layer 22. Any of various known techniques, such as physical vapor deposition (PVD) and chemical vapor deposition (CVD), may be applied to form the electrolyte layer 21. The electrolyte layer 21 is formed on the dense hydrogen permeable metal layer 22 and is thus sufficiently made thin to have a significantly reduced membrane resistance. The fuel cell 20 of this structure is accordingly driven in an operating temperature range of approximately 200 to 600° C., which is significantly lower than the operating temperature range of the prior art polymer electrolyte fuel cell.

The catalyst layer 24 functions to accelerate the electrochemical reaction proceeding on the cathode 25 and contains a noble metal, such as platinum (Pt). The cathode 25 is a gas diffusion electrode of a conductive material having gas permeability, for example, a porous metal foam or metal mesh, carbon felt, carbon paper, or a ceramic. In the structure of the first embodiment, the catalyst layer 24 is obtained by making the metal catalyst, for example, Pt supported on one plane of the cathode 25 facing to the electrolyte layer 21. The structure of the catalyst layer 24 is described in detail later.

The gas separators 27 and 29 are gas-impermeable members made of a conductive material like carbon or a metal. The gas separators 27 and 29 are preferably made of a similar material to that of the cathode 25 that is in contact with the gas separator 29. The gas separators 27 and 29 have specific patterned surfaces to define and form in-cell and inter-cell fluid conduits.

The fuel gas supplied to the fuel cells may be a hydrogen-rich gas obtained by reforming an adequate hydrocarbon fuel or a high-purity hydrogen gas. The oxidizing gas supplied to the fuel cells is typically the air. The coolant flowing through the fuel cells may be a liquid like water or a gas like the air. The fuel gas used in this embodiment is a reformed gas at the temperature of approximately 400° C., and the oxidizing gas and the coolant are the air at the temperature of approximately 25° C. In the fuel cells of this embodiment, the coolant conduits 34 are formed between every pair of adjoining unit cells 20 as shown in FIG. 1. The coolant conduits 34 may alternatively be formed at intervals of a preset number of unit cells 20.

### B. Structure of Temperature Distribution Equalizing Mechanism by Electrochemical Reaction Control

The electrochemical reaction generates heat in the process of power generation of the fuel cell. The coolant is flowed through the fuel cell as mentioned above to remove the heat and prevent an excess rise of the internal temperature of the fuel cell. The flows of the oxidizing gas and the fuel gas, as well as the flow of the coolant through the fuel cell may cause an uneven distribution of the internal temperature. In the fuel cell of this embodiment, the catalyst layer 24 is designed to function as a temperature distribution equalizing mechanism to equalize an uneven temperature distribution in the fuel cell due to the flows of such fluids.

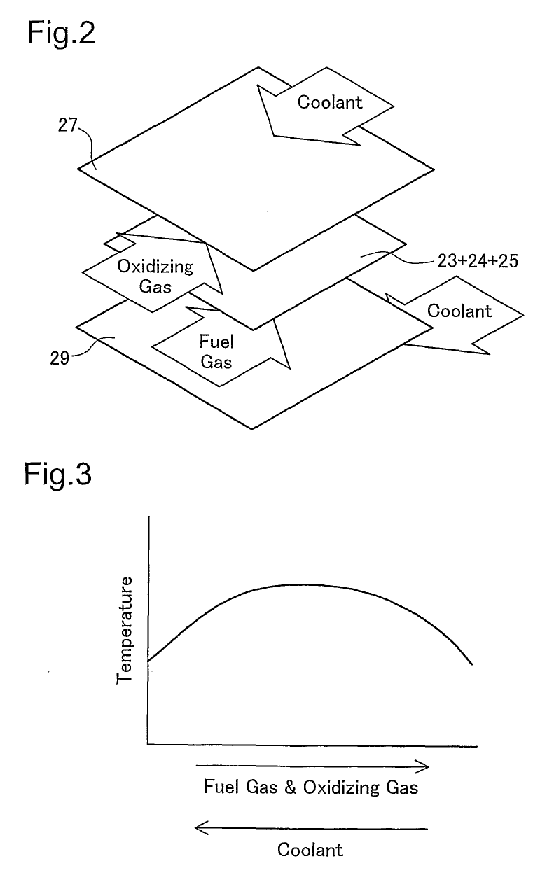

Prior to the structure of the catalyst layer 24, the description regards the flows of fluids in the fuel cell and the distribution of the internal temperature. The specific patterns formed on the faces of the gas separators 27 and 29 define the conduits to lead the total flows of the fuel gas, the oxidizing gas, and the coolant respectively in preset directions. For example, the conduits may include mutually parallel multiple grooves as shown in FIG. 1, although the conduits are not restricted to the mutually parallel multiple grooves. FIG. 2 schematically shows the flows of such fluids in one unit fuel cell 20 of the embodiment. The flow of the fuel gas running through the in-cell fuel gas conduits formed between the electrolyte module 23 (shown as the assembly ‘23+24+25’ in FIG. 2) and the gas separator 27 is parallel to the flow of the oxidizing gas running through the in-cell oxidizing gas conduits formed between the cathode 25 (shown as the assembly ‘23+24+25’ in FIG. 2) and the gas separator 29. The flow of the coolant running through the coolant conduits formed between adjoining unit cells (formed above the gas separator 27 and below the gas separator 29 in FIG. 2) is opposite to the flows of the fuel gas and the oxidizing gas.

FIG. 3 shows a temperature distribution on one unit cell plane of a stack of fuel cells without a temperature distribution equalizing mechanism when the fuel gas, the oxidizing gas, and the coolant are flowed as shown in FIG. 2. The abscissa of FIG. 3 shows the position on the unit cell plane with regard to the respective fluids flowing through the unit cell. The ordinate shows the temperature at each position on the unit cell plane. The arrows represent the directions of the flows of the respective fluids. As shown in FIG. 3, the temperature in the unit cell is low in the vicinity of inlets of the fuel gas and the oxidizing gas and in the vicinity of an inlet of the coolant, which is located opposite to the inlets of the fuel gas and the oxidizing gas, and increases toward a center portion apart from the inlets on both the ends. The temperature distribution in the fuel cell may be examined experimentally or may be simulated minutely with settings of various affecting conditions including the types, the flow rates, the temperatures, and the flow directions of the respective fluids and the materials of the respective constituents of the fuel cell.

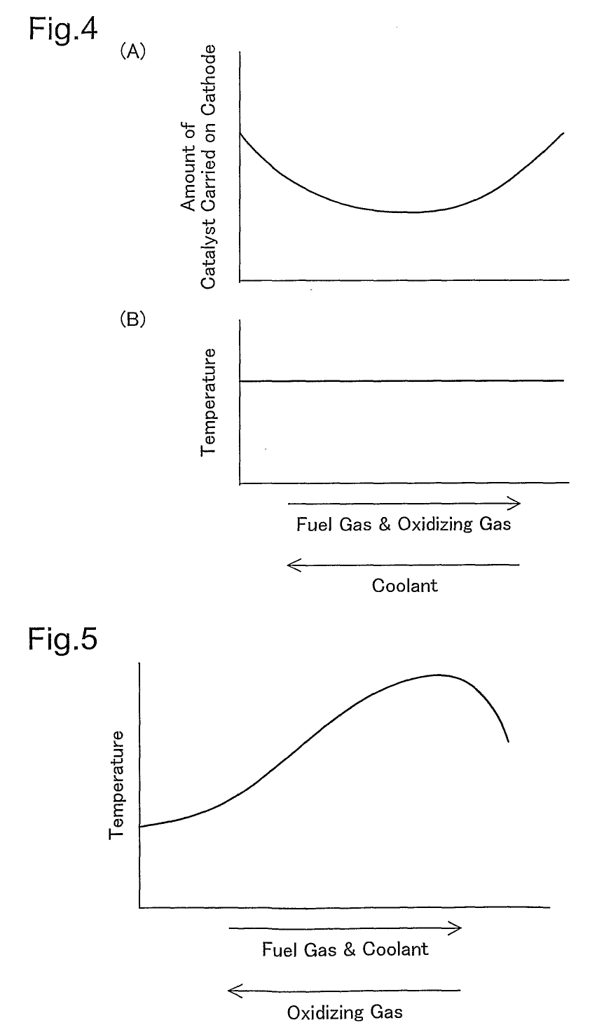

In the fuel cell of the embodiment, the catalyst layer 24 is prepared by making the metal catalyst like Pt supported on the plane of the cathode 25 facing to the electrolyte layer 21. The amount of the catalyst supported on the cathode 25 (the content of the catalyst) varies according to the position on the cathode 25. FIG. 4(A) shows a variation in content of the catalyst over the whole surface of the catalyst layer 24. FIG. 4(B) shows a temperature distribution on a unit cell plane in a stack of the fuel cells of this embodiment when the fluids are flowed in the same manner as the example of FIG. 3. Like FIG. 3, the abscissa of FIG. 4 shows the position on the unit cell plane with regard to the respective fluids flowing through the unit cell 20. As shown in FIG. 4(A), the content of the catalyst in the catalyst layer 24 is lessened in a higher temperature area and is heightened in a lower temperature area according to the temperature distribution of FIG. 3. The catalyst layer 24 is formed, for example, by applying a paste containing fine particles of the metal catalyst like Pt onto the plane of the cathode 25 facing to the electrolyte layer 21. The application quantity of the paste on the cathode 25 is varied according to the position on the cathode 25. This varies the content of the catalyst as shown in FIG. 4(A). The electrochemical reaction is suppressed in the area having the less content of the catalyst, compared with the area having the greater content of the catalyst. Such suppression interferes with a temperature rise in the higher temperature area and accordingly equalizes the temperature distribution as shown in FIG. 4(B).

In the fuel cell of this embodiment designed as discussed above, the content of the catalyst is regulated according to the temperature distribution in the fuel cell, which depends upon the temperatures and the flow directions of the respective fluids supplied to the fuel cell. The regulation lessens the content of the catalyst in a potentially higher temperature area. This arrangement effectively equalizes the actual temperature distribution in the fuel cell and thus advantageously prevents the lowered durability of the hydrogen permeable metal layer 22 and the deteriorating cell performance due to an uneven temperature distribution in the fuel cell.

### C. Other Examples of Temperature Distribution

In the structure of the first embodiment discussed above, the fuel gas and the oxidizing gas are flowed in the same direction, while the coolant is flowed in the direction opposite to the flows of the fuel gas and the oxidizing gas on the unit cell plane. The flow directions of the fluids are, however, not restricted to this embodiment. The temperature distribution in the fuel cell depends upon the flow directions of the fluids. FIGS. 5 and 7 show expected temperature distributions on the unit cell plane in other examples of the flow directions of the fluids.

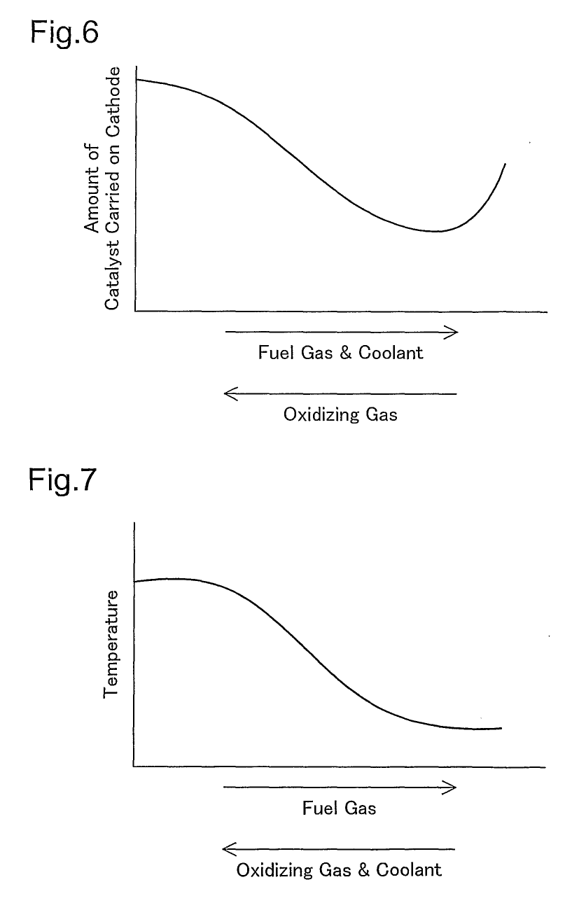

FIG. 5 shows a temperature distribution on one unit cell plane in a stack of fuel cells without a temperature distribution equalizing mechanism when the fuel gas and the coolant are flowed in the same direction and the oxidizing gas is flowed in the direction opposite to the flows of the fuel gas and the coolant. Like FIG. 3, the abscissa in FIG. 5 and FIG. 7 (described later) shows the position on the unit cell plane with regard to the respective fluids flowing through the unit cell. The ordinate shows the temperature at each position on the unit cell plane. The arrows represent the directions of the flows of the respective fluids. In the example FIG. 5, the temperature in the unit cell is low in the vicinity of inlets of the fuel gas and the coolant, gradually increases from the periphery of the inlets of the fuel gas and the coolant to the downstream, and again decreases in the vicinity of an inlet of the oxidizing gas, which is located opposite to the inlets of the fuel gas and the coolant. In the same manner as FIG. 4(A), FIG. 6 shows a variation in content of the catalyst over a catalyst layer, which is formed on the cathode as the temperature distribution equalizing mechanism, in the fuel cell with the supplies of the fluids flowed in this manner.

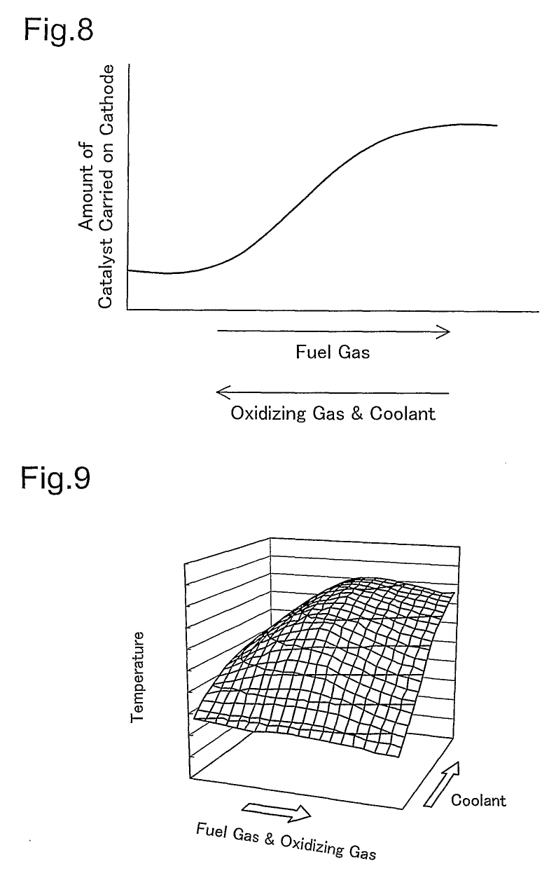

FIG. 7 shows a temperature distribution on one unit cell plane in a stack of fuel cells without a temperature distribution equalizing mechanism when the oxidizing gas and the coolant are flowed in the same direction and the fuel gas is flowed in the direction opposite to the flows of the oxidizing gas and the coolant. In the example of FIG. 7, the temperature in the unit cell reaches the maximum in the vicinity of an inlet of the fuel gas and gradually decreases towards the periphery of inlets of the oxidizing gas and the coolant, which are located opposite to the inlet of the fuel gas. In the same manner as FIG. 4(A), FIG. 8 shows a variation in content of the catalyst over a catalyst layer, which is formed on the cathode as the temperature distribution equalizing mechanism, in the fuel cell with the supplies of the fluids flowed in this manner.

In either of these examples, the content of the catalyst is lessened in a higher temperature area and is increased in a lower temperature area. This arrangement suppresses the electrochemical reaction in the higher temperature area and thereby equalizes the temperature distribution in the fuel cell.

FIG. 9 shows a temperature distribution on one unit cell plane in a stack of fuel cells without a temperature distribution equalizing mechanism when the fuel gas and the oxidizing gas are flowed in the same direction and the coolant is flowed in the direction perpendicular to the flows of the fuel gas and the oxidizing gas. The bottom face in the drawing of FIG. 9 represents a unit cell plane. The variation in temperature on the unit cell plane is expressed by the height from the unit cell plane. The open arrows represent the flow directions of the respective fluids. The supplies of fuel gas and oxidizing gas have lower temperatures than the internal temperature of the fuel cell. In the example of FIG. 9, the temperature accordingly rises in a downstream region of the flows of the fuel gas and the oxidizing gas on the unit cell plane. The temperature reaches the minimum in the vicinity of an inlet of the coolant. The temperature distribution equalizing mechanism is provided in the fuel cell of this structure to reduce heat generation in a higher temperature area. In any of these structures, the temperature distribution equalizing mechanism is designed to control the electrochemical reaction according to the temperature distribution in the fuel cell and suppress the electrochemical reaction in a potentially higher temperature area. This arrangement thus effectively equalizes the temperature distribution in the fuel cell.

In general, the temperature is lowered in the vicinity of an inlet of a low temperature fluid, for example, in the vicinity of an inlet of a low temperature coolant and/or a low temperature oxidizing gas, and gradually increases with a distance from the inlet of the low temperature fluid. This causes an uneven temperature distribution in the fuel cell. The temperature distribution equalizing mechanism is thus provided to reduce heat generation in an area apart from the inlet of the low temperature fluid. A reformed gas fed from a reformer generally has a higher temperature than the hydrogen gas stored in a hydrogen tank. The reformed gas used as the fuel gas tends to excessively raise the temperature in a specific area of the fuel cell and cause an uneven temperature distribution. The arrangement of the invention is thus effectively applicable to the structure of using the reformed gas as the fuel gas, in order to restrain a temperature rise in the specific area and thereby equalize the temperature distribution in the fuel cell.

The fuel cell may have multiple cooling systems for the flows of multiple different coolants. In this structure, a distribution of the internal temperature of the fuel cell depends upon the temperatures of the respective coolants and the efficiencies of heat exchange of the respective coolants. The structure of making the fuel gas, the oxidizing gas, and the coolant flow in the respective fixed directions may be replaced by a modified structure of changing the flow directions in the middle. In any structure, the distribution of the internal temperature may be simulated with settings of the flow conditions of the respective fluids or may be examined experimentally. The temperature distribution equalizing mechanism is provided according to the results of the simulation or the experiment.

The above description regards the uneven temperature distribution on the unit cell plane with reference to the examples of FIGS. 2 through 9. With regard to a fuel cell stack or a laminate of multiple unit cells, it is preferable to provide a temperature distribution equalizing mechanism by taking into account a total temperature distribution in the whole stack structure including the laminating direction of unit cells.

For example, on the assumption that only the conditions of the respective fluids affect the temperature distribution in the fuel cell stack and that the respective fluids are flowed in each unit cell as shown in FIG. 2, the temperature distribution equalizing mechanism is provided in each unit cell of the stack structure as described above. Heat dissipation generally lowers the temperature in the outer periphery of the fuel cell stack. The temperature distribution equalizing mechanism is preferably designed to sufficiently equalize the temperature distribution in the whole stack structure of fuel cells, which is affected by combinations of various expected conditions, for example, a combination of gas flow conditions and heat dissipation conditions. The internal temperature of the fuel cells is affected by the surroundings of the fuel cells. For example, when a certain heating device is located in the vicinity of the fuel cells, the closer distance to the heating device gives the higher internal temperature of the fuel cells. The temperature distribution equalizing mechanism is arranged by taking into account diversity of factors affecting the distribution of the internal temperature of the fuel cells. This ensures the enhanced effects of the temperature distribution equalizing mechanism. When the temperature distribution equalizing mechanism is provided according to the temperature distribution in the whole stack structure of fuel cells, the temperature distribution equalizing mechanism may not be arranged uniformly in corresponding planes of respective unit cells but may be designed to be effective as the whole stack structure. For example, in the technique of varying the content of the catalyst supported on the cathode to equalize the temperature distribution as discussed in the first embodiment, some unit cells in the fuel stack structure may homogeneously have a less content of the catalyst supported on the respective cathodes, while other unit cells may homogeneously have a greater content of the catalyst supported on the respective cathodes.

### D. Other Embodiments of Electrochemical Reaction Control

### D-1. Second Embodiment

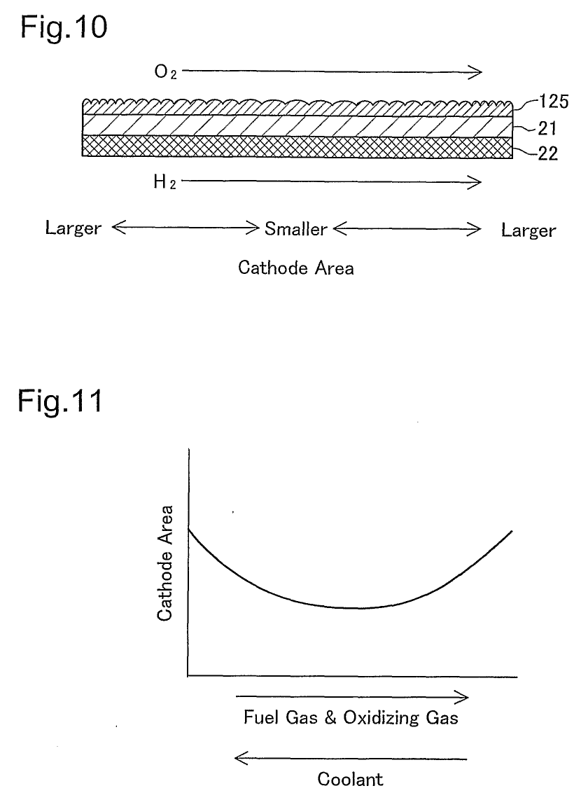

FIG. 10 is a sectional view schematically illustrating the structure of a fuel cell in a second embodiment of the invention. The gas separators 27 and 29 are omitted from the illustration, and FIG. 10 shows only the structure of an electrolyte module and a cathode 125 included in the fuel cell of the second embodiment. The fuel cell of the second embodiment has a similar structure to that of the fuel cell 20 of the first embodiment, except that the catalyst layer 24 and the cathode 25 are replaced by the cathode 125. The cathode 125 is a thin metal membrane of a noble metal having catalytic activity and functioning as the catalyst of the electrochemical reaction, for example, Pt, a Pt alloy, Pd, or a Pd alloy. When the selected material for the cathode 125 is a hydrogen impermeable metal, such as Pt, the cathode 125 is formed sufficiently thin to ensure the required gas permeability. The cathode 125 may be formed on the electrolyte layer 21 deposited over the hydrogen permeable metal layer 22 by plating or by PVD or CVD. In the fuel cell of the second embodiment and fuel cells of third and fourth embodiments (discussed later), the fuel gas, the oxidizing gas, and the coolant are flowed in the same directions as those in the fuel cell of the first embodiment.

As shown in FIG. 10, the cathode 125 has a varying patterned indented surface structure to vary the surface area of the electrode in an identical plane. Any adequate technique, for example, argon ion etching or shot blast, is applied to treat the surface of the cathode 125 to form the patterned indented surface structure. In the structure of this embodiment, the patterned indented surface structure is varied according to the position on the cathode 125 to vary the effective surface area per unit area of the cathode 125 in the identical plane.

FIG. 11 shows a variation in surface area of the cathode 125 under the conditions of the fluids flowed in the same directions as those in the example of FIG. 4. The cathode 125 has a varying surface area according to the temperature distribution shown in FIG. 3 to have the smaller surface area in the higher temperature range and the greater surface area in the lower temperature range. This arrangement suppresses the electrochemical reaction and thereby interferes with a temperature rise in the range of the smaller surface area, compared with the range of the greater surface area. The structure of the second embodiment thus effectively equalizes the temperature distribution in the fuel cells, like the structure of the first embodiment.

### D-2. Third Embodiment

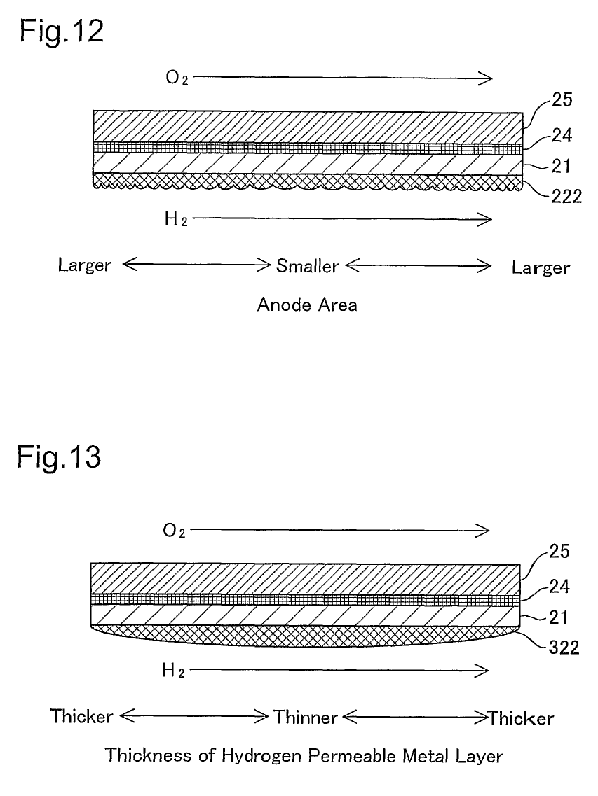

FIG. 12 is a sectional view schematically illustrating the structure of a fuel cell in a third embodiment of the invention. The fuel cell of the third embodiment has a similar structure to that of the fuel cell 20 of the first embodiment, except that the hydrogen permeable metal layer 22 is replaced by another hydrogen permeable layer 222. The gas separators 27 and 29 are omitted from the illustration of FIG. 12 as in the illustration of FIG. 10.

The hydrogen permeable metal layer 222 is made of a hydrogen permeable metal similarly to the hydrogen permeable metal layer 22 of the first embodiment but has a varying patterned indented surface structure. The varying patterned indented surface structure of the hydrogen permeable metal layer 222 is designed to vary the effective surface area of the electrode in an identical plane. Like the cathode 125 of the second embodiment, any adequate technique, for example, argon ion etching or shot blast, is applied to treat the surface of the hydrogen permeable metal layer 222 to form the patterned indented surface structure. In the structure of this embodiment, the patterned indented surface structure is varied according to the position on the hydrogen permeable metal layer 222 to vary the surface area of the hydrogen permeable metal layer 222 in the identical plane. One face of the hydrogen permeable metal layer 222 may be treated to form the varying patterned indented surface structure before or after deposition of the electrolyte layer 21 on the other face of the hydrogen permeable metal layer 222.

As with the cathode 125 of the second embodiment, the hydrogen permeable metal layer 222 of the third embodiment shown in FIG. 12 has a varying surface area according to the temperature distribution shown in FIG. 3 to have the smaller surface area in the higher temperature range and the greater surface area in the lower temperature range. The hydrogen permeable metal layer 222 functions as an anode. The greater surface area of the hydrogen permeable metal layer 222 increases the effective surface area of the electrode having the electrochemical reaction. This arrangement suppresses the electrochemical reaction and thereby interferes with a temperature rise in the range of the smaller surface area, compared with the range of the greater surface area. The structure of the third embodiment thus effectively equalizes the temperature distribution in the fuel cells, like the structure of the first embodiment.

### D-3. Fourth Embodiment

FIG. 13 is a sectional view schematically illustrating the structure of a fuel cell in a fourth embodiment of the invention. The fuel cell of the fourth embodiment has a similar structure to that of the fuel cell 20 of the first embodiment, except that the hydrogen permeable metal layer 22 is replaced by another hydrogen permeable layer 322. The gas separators 27 and 29 are omitted from the illustration of FIG. 13 as in the illustration of FIG. 10.

The hydrogen permeable metal layer 322 is made of a hydrogen permeable metal similarly to the hydrogen permeable metal layer 22 of the first embodiment but has a varying thickness in an identical plane. The hydrogen permeable metal layer 322 is formed to have a varying thickness according to the temperature distribution shown in FIG. 3, that is, to be thicker in a higher temperature area and thinner in a lower temperature area. The thicker hydrogen permeable metal layer reduces the quantity of hydrogen permeation through the hydrogen permeable metal layer. This arrangement suppresses the electrochemical reaction and thereby interferes with a temperature rise in the range of the thicker hydrogen permeable metal layer, compared with the range of the thinner hydrogen permeable metal layer. The structure of the fourth embodiment thus effectively equalizes the temperature distribution in the fuel cells.

The hydrogen permeable metal layer 322 may be made of Pd or a Pd alloy similarly to the hydrogen permeable metal layer 22, or may alternatively be formed as a Pd-containing layer on at least one face of a group 5 metal-containing base material layer facing to the fuel gas conduits. The Pd-containing layer provided on at least one face of the group 5 metal-containing base material layer facing to the fuel gas conduits ensures the sufficient activity of dissociating hydrogen molecules passing through the hydrogen permeable metal layer 322. When a Pd-containing layer is formed on the base material layer, at least one of the thicknesses of the base material layer and the Pd-containing layer is varied to change the total thickness of the hydrogen permeable metal layer 322 as shown in FIG. 13.

In the structures of the first through the fourth embodiments discussed above, the content of the catalyst, the effective surface area of the cathode, the effective surface area of the anode, or the thickness of the hydrogen permeable metal layer is gradually varied between the potentially higher temperature area and the potentially lower temperature area according to the temperature distribution shown in FIG. 3. The variation may alternatively be made stepwise. For example, the electrode or the hydrogen permeable metal layer is divided into multiple zones with a temperature change from the higher temperature to the lower temperature. The content of the catalyst, the effective surface area of the cathode, the effective surface area of the anode, or the thickness of the hydrogen permeable metal layer may be changed stepwise in such multiple zones. Any of the structure of varying the content of the catalyst, the structure of varying the effective surface area of the cathode, the structure of varying the effective surface area of the anode, and the structure of varying the thickness of the hydrogen permeable metal layer may be combined to more effectively equalize the temperature distribution in the fuel cells.

### D-4. Other Examples of Controlling Power Generation-Induced Heat Generation

The temperature distribution equalizing mechanism to equalize the distribution of the internal temperature of the fuel cell is the catalyst layer with the varying content of the catalyst in the structure of the first embodiment, is the cathode with the varying effective surface area of the cathode in the structure of the second embodiment, is the hydrogen permeable metal layer with the varying effective surface area of the anode in the structure of the third embodiment, and is the hydrogen permeable metal layer with the varying thickness in the structure of the fourth embodiment. Diversity of other structures that suppress the electrochemical reaction are also applicable to effectively equalize the distribution of the internal temperature of the fuel cells. For example, the varying internal structure of the hydrogen permeable metal layer exerts the similar effects to those of the varying thickness of the hydrogen permeable metal layer. The following describes some examples of varying the internal structure of the hydrogen permeable metal layer (the composition and/or the layout of the hydrogen permeable metal layer) to control the quantity of hydrogen permeation in a potentially higher temperature area, thus reducing power generation-induced heat generation and equalizing the temperature distribution in the fuel cells.

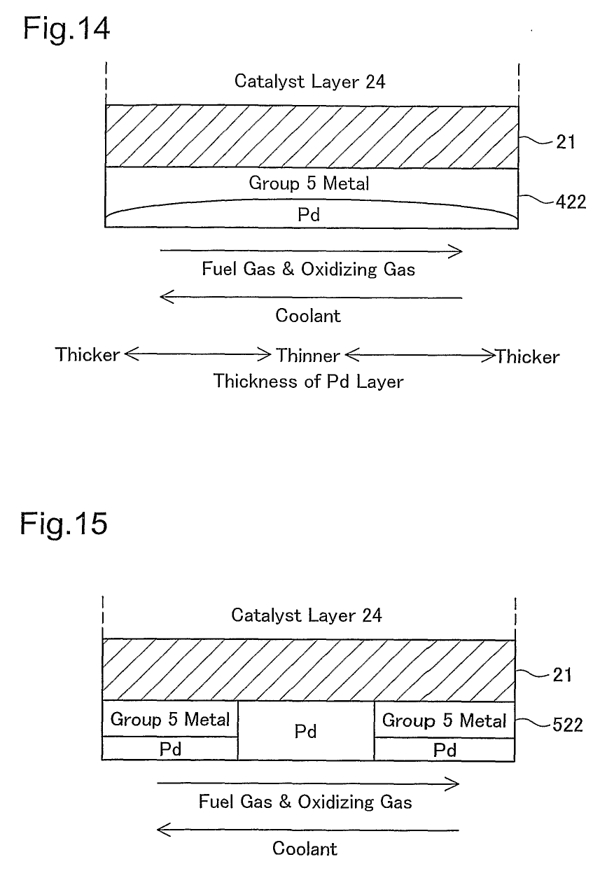

FIG. 14 is a sectional view schematically illustrating the structure of another fuel cell including a hydrogen permeable metal layer having a varying internal structure in one example. The fuel cell of this example has a similar structure to that of the fuel cell 20 of the first embodiment, except that the hydrogen permeable metal layer 22 is replaced by another hydrogen permeable layer 422. FIG. 14 and FIGS. 15 through 17 (discussed later) mainly show the characteristic structures of hydrogen permeable metal layers. The hydrogen permeable metal layer 422 includes a group 5 metal-containing base material layer and a Pd-containing layer formed on the base material layer. The Pd-containing layer is made thicker and the group 5 metal-containing base material layer is made thinner in a potentially higher temperature area. Pd has the lower hydrogen permeability than the group 5 metals. This arrangement accordingly suppresses the electrochemical reaction in the range of the thicker Pd-containing layer, compared with the range of the thinner Pd-containing layer, thus effectively equalizing the temperature distribution in the fuel cell. In the example of FIG. 14, the thicknesses of the Pd-containing layer and the group 5 metal-containing base material layer are gradually varied. The variation may alternatively be made stepwise. For example, the hydrogen permeable metal layer is divided into multiple zones with a temperature change from the higher temperature to the lower temperature. The thicknesses of the Pd-containing layer and the group 5 metal-containing base material layer may be varied stepwise in the respective zones. The Pd-containing layer may be formed on both faces of the group 5 metal-containing base material layer.

FIG. 15 is a sectional view schematically illustrating the structure of still another fuel cell including a hydrogen permeable metal layer having a varying internal structure in another example. The fuel cell of this example has a similar structure to that of the fuel cell 20 of the first embodiment, except that the hydrogen permeable metal layer 22 is replaced by another hydrogen permeable layer 522. The hydrogen permeable metal layer 522 has a Pd-containing layer alone in a specific area expected to have a higher temperature, while having both a group 5 metal-containing base material layer and a Pd-containing layer formed on the base material layer in residual areas. Pd has the lower hydrogen permeability than the group 5 metals. This arrangement accordingly suppresses the electrochemical reaction in the specific area having only the Pd-containing layer, compared with the residual areas, thus effectively equalizing the temperature distribution in the fuel cell.

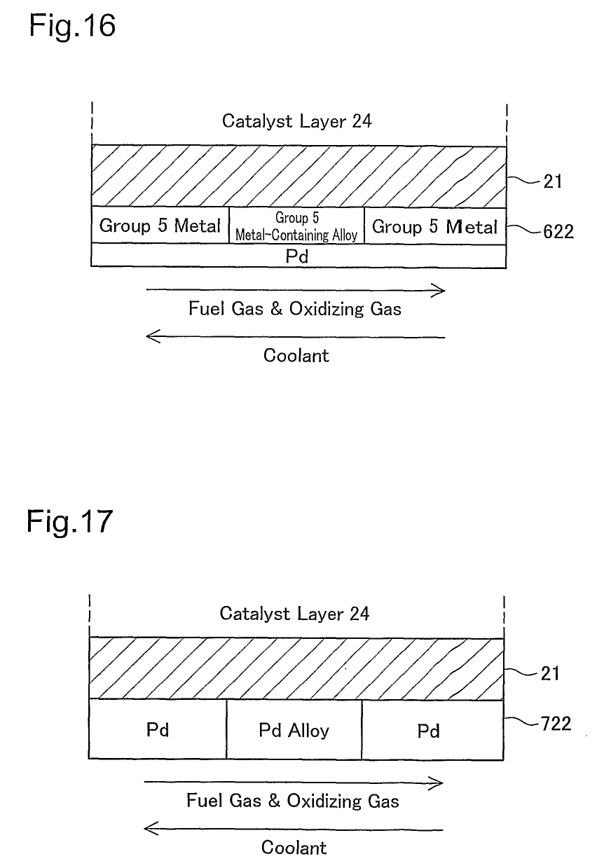

In another applicable technique, a potentially higher temperature area is set to have a lower content of the hydrogen permeable metal in the hydrogen permeable metal layer, while a potentially lower temperature area is set to have a higher content of the hydrogen permeable metal in the hydrogen permeable metal layer. A fuel cell of this technique shown in FIG. 16 has a similar structure to that of the fuel cell 20 of the first embodiment, except that the hydrogen permeable metal layer 22 is replaced by another hydrogen permeable metal layer 622. The whole area of the hydrogen permeable metal layer 622 has a group 5-metal containing base material layer and a Pd-containing layer formed on the base material layer. The group 5 metal-containing base material layer is made of a group 5 metal-containing alloy in a specific area expected to have a higher temperature, while being made of a pure group 5 metal in residual areas. Another fuel cell of this technique shown in FIG. 17 has a similar structure to that of the fuel cell 20 of the first embodiment, except that the hydrogen permeable metal layer 22 is replaced by another hydrogen permeable metal layer 722. The whole area of the hydrogen permeable metal layer 722 has only a Pd-containing layer. The Pd-containing layer is made of pure Pd in a specific area expected to have a higher temperature, while being made of a Pd-containing alloy in residual areas. In either of these structures, the electrochemical reaction is suppressed in the range of the lower content of the hydrogen permeable metal, compared with the range of the higher content of the hydrogen permeable metal. Such structures of this technique control the hydrogen permeation and thereby suppress the electrochemical reaction in the specific area expected to have the higher temperature relative to the residual areas. This arrangement effectively equalizes the temperature distribution in the fuel cell.

Any structure of the second through the fourth embodiments and their modified examples discussed above is applicable to the various flow directions of the fluids shown in FIGS. 5, 7, and 9. Under the conditions of various flow directions of the fluids, the temperature distribution equalizing mechanism may be an electrode having the varying content of the catalyst, an electrode having the varying surface area, or an electrolyte module having the varying thickness of the hydrogen permeable metal layer, according to the temperature distribution caused by the fluid flows. Any of these arrangements suppresses the electrochemical reaction in a potentially higher temperature area and thus equalizes the temperature distribution. In a stack of fuel cells, the temperature distribution equalizing mechanism may be provided by taking into account various factors affecting the temperature distribution, in addition to the flow directions of the fluids. The temperature distribution equalizing mechanism is arranged according to the positions of the respective unit cells in the stack structure, so as to suppress the electrochemical reaction in potentially higher temperature areas and thereby equalize the temperature distribution in the whole stack structure.

### E. Other Embodiments of Temperature Distribution Equalizing Mechanism

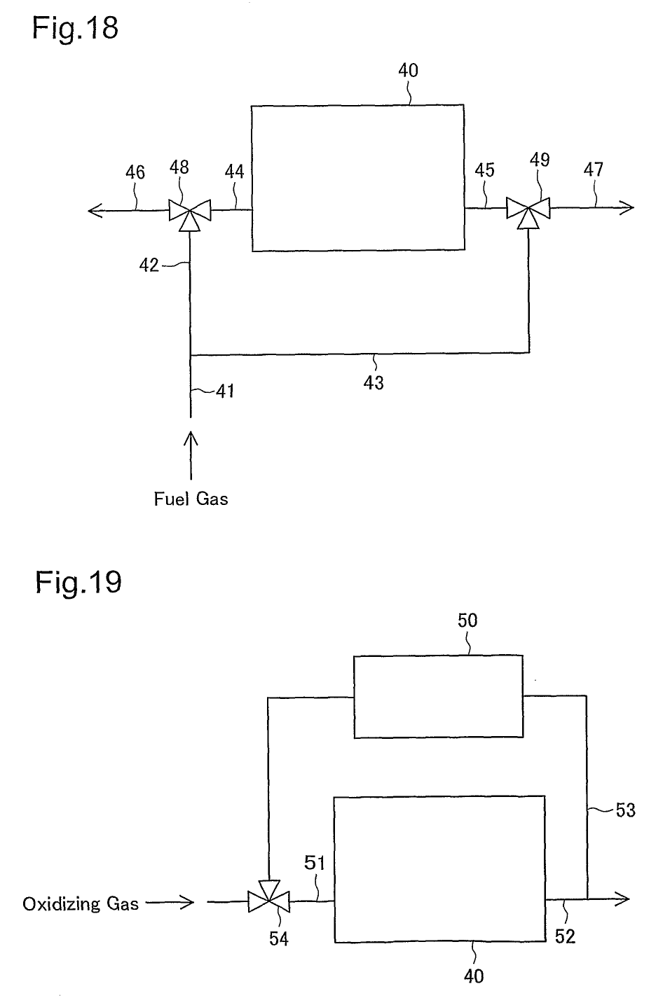

The temperature distribution equalizing mechanism in any of the embodiments discussed above suppresses the electrochemical reaction in a potentially higher temperature area and thereby equalizes the temperature distribution in the fuel cells. The temperature distribution equalizing mechanism may adopt another method to equalize the temperature distribution. FIG. 18 schematically illustrates the configuration of a fuel cell device in a fifth embodiment of the invention.

The fuel cell device of the fifth embodiment includes a stack of fuel cells 40 with supplies of the fuel gas, the oxidizing gas, and the coolant, which are the same as those of the first embodiment. The stack of fuel cells 40 includes a large number of unit cells having the similar structure to that of the unit fuel cell 20 shown in FIG. 1. The fuel cell device of the fifth embodiment has a temperature distribution equalizing mechanism to change over the flow direction of the fluid gas supplied to the fuel cells, unlike the temperature distribution equalizing portion of the first embodiment that has the catalyst layer with the varying content of the catalyst. FIG. 18 shows only the structure involved in changeover of the flow direction of the fluid gas.

The fuel gas flows through a fuel gas conduit 41 and is fed into the fuel cell stack 40. The fuel gas conduit 41 diverges into a first branch pathway 42 and a second branch pathway 43. The first branch pathway 42 further diverges into a first flow path 44 and a first exhaust path 46. A directional control valve 48 is provided at a diverging point of the first branch pathway 42 into the first flow path 44 and the first exhaust path 46 to regulate the communication of these three passages. The first flow path 44 is connected to the fuel cell stack 40, specifically to the fuel gas conduits in the respective unit cells of the fuel cell stack 40. The second branch pathway 43 further diverges into a second flow path 45 and a second exhaust path 47. A directional control valve 49 is provided at a diverging point of the second branch pathway 43 into the second flow path 45 and the second exhaust path 47 to regulate the communication of these three passages. The second flow path 45 is connected to the fuel cell stack 40, specifically to the fuel gas conduits in the respective unit cells of the fuel cell stack 40.

In the fuel cell device of this embodiment, the directional control valves 48 and 49 are regulated to change over the flow direction of the fuel gas in the fuel cell stack 40 between a first direction and a second direction, which are opposite to each other. When the first direction is selected as the flow direction of the fuel gas, the fuel gas flows through the first branch pathway 42 and the first flow path 44 into the fuel cell stack 40 and is discharged through the second flow path 45 and the second exhaust path 47 to the outside. When the second direction is selected as the flow direction of the fuel gas, on the other hand, the fuel gas flows through the second branch pathway 43 and the second flow path 45 into the fuel cell stack and is discharged through the first flow path 44 and the first exhaust path 46 to the outside.

On the unit cell plane in the fuel cell stack 40 of the fifth embodiment, the flow direction of the oxidizing gas is opposed to the flow direction of the coolant, and the fuel gas is flowed in parallel with the flows of the oxidizing gas and the coolant. Under such conditions, the state in which the fuel gas is flowed in the first direction corresponds to the state of FIG. 3, while the state in which the fuel gas is flowed in the second direction corresponds to the state of FIG. 5. The fixed flow directions of the oxidizing gas and the coolant are shown reversely in the graphs of FIGS. 3 and 5. Regulation of the directional control valves 48 and 49 to change over the flow direction of the fuel gas switches over the temperature distribution on the unit cell plane between the state of FIG. 3 and the state of FIG. 5. The potentially higher temperature area and the potentially lower temperature area in the state of FIG. 3 are different from those in the state of FIG. 5. The changeover of the flow direction of the fuel gas thus desirably prevents the temperature from excessively increasing or decreasing in any specific area, thus effectively equalizing the temperature distribution.

The flow direction of the fuel gas may be changed over at preset time intervals by regulating the directional control valves 48 and 49. Another procedure may measure the temperature at a selected site in the fuel cell stack 40 or the temperature of an anode-off gas and change over the flow direction of the fuel gas when the measured temperature reaches or exceeds a reference temperature as an upper limit or is lowered to or below a reference temperature as a lower limit.

The structure of the fifth embodiment adopts the temperature distribution equalizing mechanism of changing over the flow direction of the fuel gas. One modified structure may change over the flow direction of the oxidizing gas, that is, the other reactive gas subjected to the electrochemical reaction. For example, the flow direction of the oxidizing gas is changed over on the assumption that the flow direction of the fuel gas is opposed to the flow direction of the coolant and the flow of the oxidizing gas is parallel to the flows of the fuel gas and the coolant. Under such conditions, the state in which the oxidizing gas is flowed in the first direction corresponds to the state of FIG. 3, while the state in which the oxidizing gas is flowed in the second direction corresponds to the state of FIG. 7. The changeover of the flow direction of the oxidizing gas switches over the temperature distribution on the unit cell plane between the state of FIG. 3 and the state of FIG. 7, thus achieving the similar effects of equalizing the temperature distribution.

### E-2. Sixth Embodiment

FIG. 19 shows the configuration of a fuel cell device in a sixth embodiment. The fuel cell device of the sixth embodiment has the fuel cell stack 40 similarly to the fifth embodiment and a temperature distribution equalizing mechanism relating to circulation of the oxidizing gas. FIG. 19 shows only the structure involved in circulation of the oxidizing gas.

The oxidizing gas flows through an oxidizing gas supply conduit 51 into the fuel cell stack 40 and is consumed on the cathodes in the fuel cell stack 40. The oxidizing gas exhaust is discharged as a cathode-off gas from the fuel cell stack 40 to an oxidizing gas exhaust conduit 52. An oxidizing gas circulation pathway 53 is provided to connect the oxidizing gas exhaust conduit 52 to the oxidizing gas supply conduit 51. At least part of the cathode-off gas is flowed through the oxidizing gas circulation pathway 53 to be mixed with the new supply of the oxidizing gas into the fuel cell stack 40. A heat exchanger 50 is provided in the middle of the oxidizing gas circulation pathway 53 to cool down the cathode-off gas prior to being mixed with the new supply of the oxidizing gas. A directional control valve 54 is provided at a joint of the oxidizing gas circulation pathway 53 with the oxidizing gas supply conduit 51. Control of this directional control valve 54 regulates the amount of the cathode-off gas mixed with the new supply of the oxidizing gas and thereby adjusts the temperature of the oxidizing gas supplied to the fuel cell stack 40.

In the fuel cell device of the sixth embodiment, the temperature of the oxidizing gas is lowered before the supply to the fuel cell stack 40. This arrangement effectively prevents the temperature from excessively rising in any specific area in the fuel cell stack 40. For example, on the assumption of the temperature distribution on the unit cell plane shown in FIG. 5 with the flow direction of the oxidizing gas opposite to the flow direction of the fuel gas and the coolant, the structure of lowering the temperature of the oxidizing gas flowed into the fuel cell stack decreases the temperature in the vicinity of the inlet of the oxidizing gas. This arrangement effectively prevents the temperature from excessively rising in any specific area of the fuel cell stack 40, thus equalizing the temperature distribution in the fuel cell stack 40. This technique of lowering the temperature of the oxidizing gas supplied to the fuel cell stack 40 is effectively applicable to various states other than the state of FIG. 5 in which the internal temperature of the fuel cell stack 40 is unevenly distributed due to the temperatures and the flow directions of the fluids. In any state, the temperature distribution is equalized. For example, the surroundings of the fuel cell stack 40 may cause the upstream side of the flow of the oxidizing gas to be externally heated and have a higher temperature. The lowered temperature of the supply of the oxidizing gas effectively equalizes the temperature distribution in the fuel cell stack 40.

Any of diverse coolants may be used in the heat exchanger 50 to lower the temperature of the cathode-off gas. For example, when the reformed gas is selected as the fuel gas, the coolant may be water used for the steam reforming reaction. In this structure, water is heated prior to the reforming reaction. The structure of using the heat exchanger 50 to cool the cathode-off gas down may be replaced by another structure of utilizing the cathode-off gas to heat a reformer unit and thereby cooling the cathode-off gas down. Another example is a radiator to release heat from the cathode-off gas. Any of other diverse structures is applicable to lower the temperature of the cathode-off gas.

The structure of the sixth embodiment adopts the temperature distribution equalizing mechanism of circulating the oxidizing gas to lower the temperature of the oxidizing gas. One modified structure may circulate the fuel gas, that is, the other reactive gas subjected to the electrochemical reaction, to lower the temperature of the fuel gas. The lowered temperature of the fuel gas supplied to the fuel cell stack effectively prevents the temperature from rising in any specific area in the fuel cell stack and thereby equalizes the temperature distribution. The structure of this embodiment is applicable to both the pure hydrogen gas and the reformed gas used as the fuel gas.

### E-3. Seventh Embodiment

The first through the sixth embodiments discussed above supply the hydrogen-containing fuel gas to the anodes of the fuel cells. In another available structure, a reforming catalyst is supported in gas conduits on the anode side of the fuel cells. A hydrocarbon fuel and steam are supplied to the fuel cells to be subjected to a reforming reaction. This structure is described below as a seventh embodiment.

In the structure of this embodiment, the reforming catalyst is supported on the surface of the gas separators, which define the fuel gas conduits, in the respective unit fuel cells. For example, one concrete procedure coats the surface of gas separators made of metal thin plates with alumina or cordierite and fires the ceramic-coated gas separators to form porous layers on the gas separators. The reforming catalyst is then supported on the porous layers. When platinum is selected as the reforming catalyst, the procedure soaks the gas separators with the porous layers in a solution of a platinum compound and makes the platinum supported on the porous layers by any known technique, for example, ion exchange, impregnation, or evaporation.

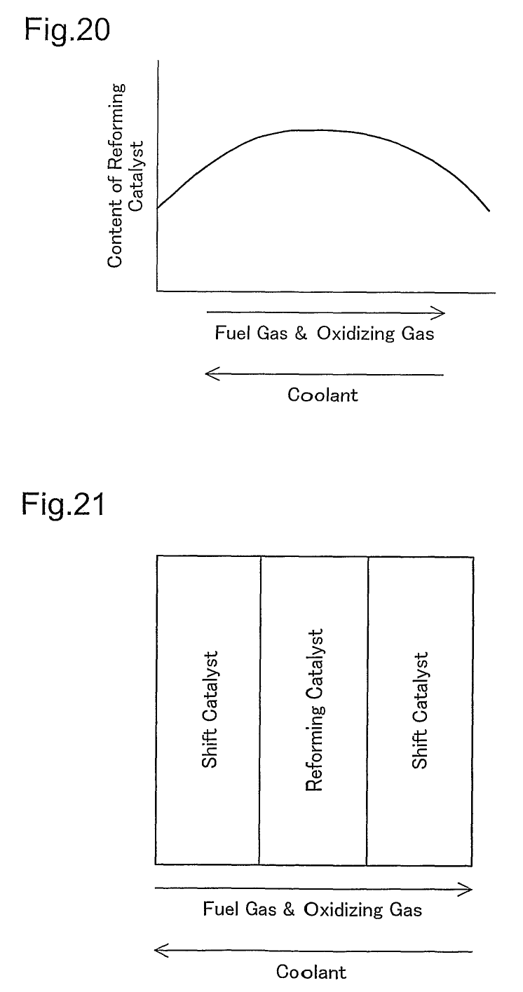

FIG. 20 shows a variation in content of the reforming catalyst supported on the surface of the gas separator that defines the fuel gas conduits in each unit cell in the fuel cell stack of this embodiment. Like FIG. 4(A), the graph of FIG. 20 is given on the assumption of the temperature distribution on the unit cell plane shown in FIG. 3 in the absence of the temperature distribution equalizing mechanism with the fuel gas, the oxidizing gas, and the coolant flowed in the same directions as those of the first embodiment. As shown in FIG. 20, the content of the reforming catalyst increases in a potentially higher temperature area and decreases in a potentially lower temperature area according to the temperature distribution of FIG. 3.

In this structure, the greater content of the reforming catalyst is set in the area expected to have the higher temperature. The endothermic steam reforming reaction vigorously proceeds in this potentially higher temperature area to interfere with a temperature rise and thereby equalize the temperature distribution.

In the structure of this embodiment, the content of the reforming catalyst supported on the gas separator is gradually varied according to the expected temperature distribution on the unit cell plane in the absence of the temperature distribution equalizing mechanism as shown in FIG. 20. One possible modification may vary the content of the reforming catalyst stepwise. The modified procedure masks selected zones on the surface of the porous layer of the gas separator according to the expected temperature distribution to vary the content of the reforming catalyst in respective zones.

Another possible modification may form catalyst layers of the reforming catalyst separately from the unit fuel cells for power generation, instead of making the reforming catalyst on the surface of the gas separators that define the fuel gas conduits in the respective unit fuel cells. The modified procedure inserts the catalyst layers at intervals of every preset number of unit fuel cells in the stack structure. In the stack of fuel cells having this structure, the reforming reaction proceeds on the catalyst layers, while hydrogen produced by the reforming reaction is supplied to the respective unit fuel cells to be subjected to the electrochemical reaction. The content of the catalyst is varied on the plane of each catalyst layer as shown in FIG. 20. This modified structure causes heat transfer between the unit cells and the catalyst layers and thereby exerts the similar effects to those of the structure of the seventh embodiment.

The content of the reforming catalyst may be varied according to the position of the laminate in the stack structure of fuel cells, in addition to or in place of the structure of varying the content of the reforming catalyst on each unit cell plane. In the case where the temperature is lowered on both ends of the stack structure, the content of the reforming catalyst is lessened on the gas separators located on the ends of the stack structure and is increased on the gas separators located on the center of the stack structure.

### E-4. Eighth Embodiment

The structure of the seventh embodiment sets the greater content of the reforming catalyst in the area expected to have the higher temperature for the vigorous endothermic reaction. Another available structure additionally uses a shift catalyst for accelerating the shift reaction to equalize the temperature distribution. This structure is described below as an eighth embodiment.

The structure of this embodiment uses both a catalyst of vigorously accelerating the reforming reaction and a catalyst of vigorously accelerating the shift reaction, which produces hydrogen and carbon dioxide from carbon monoxide and steam, under the temperature conditions in the fuel cells. The catalyst actually used has both the activities of the reforming catalyst and the shift catalyst. In the description below, the catalyst of mainly accelerating the reforming reaction and the catalyst of mainly accelerating the shift reaction under the temperature conditions in the fuel cells are respectively called the reforming catalyst and the shift catalyst. Available examples of the reforming catalyst are a copper-zinc (Cu—Zn) supported catalyst and an iron-chromium (Fe—Cr) supported catalyst. One available example of the shift catalyst is a nickel (Ni) supported catalyst.

FIG. 21 shows catalysts supported on the surface of the gas separator that defines the fuel gas conduits in each unit cell in the fuel cell stack of this embodiment. The structure of this embodiment is determined on the assumption of the temperature distribution on the unit cell plane shown in FIG. 3 in the absence of the temperature distribution equalizing mechanism with the fuel gas, the oxidizing gas, and the coolant flowed in the same directions as those of the first embodiment. The reforming catalyst is accordingly supported on a potentially higher temperature area, whereas the shift catalyst is supported on a potentially lower temperature area.

In this structure, the reforming catalyst is supported on the area expected to have the higher temperature. The endothermic steam reforming reaction accordingly proceeds to interfere with a temperature rise in this potentially higher temperature area. The shift catalyst is supported on the area expected to have the lower temperature. The endothermic shift reaction accordingly proceeds to accelerate a temperature rise in this potentially lower temperature area. This arrangement effectively equalizes the temperature distribution on each unit cell plane.

In the structure of this embodiment, either the reforming catalyst or the shift catalyst is selectively supported on each zone of the gas separator as shown in FIG. 21. One possible modification may make both the reforming catalyst and the shift catalyst supported on the whole area of the gas separator, and vary the contents of these catalysts in respective zones of the gas separator. The similar effects to those of the structure of the eighth embodiment are achieved by increasing the content of the reforming catalyst in the potentially higher temperature area and increasing the content of the shift catalyst in the potentially lower temperature area. Another possible modification may provide catalyst layers having the varying contents of the reforming catalyst and the shift catalyst in respective zones separately from the unit fuel cells and insert the catalyst layers at intervals of every preset number of unit cells in the stack structure. Hydrogen produced on the catalyst layers is supplied to the unit cells to be subjected to the electrochemical reaction. In the event of an uneven temperature distribution according to the position of the laminate in the stack structure, the content of the reforming catalyst is increased on the gas separators located at the higher temperature position, while the content of the shift catalyst is increased on the gas separators located at the lower temperature position.

### E-5. Ninth Embodiment

Still another available structure makes the shift catalyst supported on the surface of the gas separators that define the fuel gas conduits in the respective unit fuel cells and supplies the reformed gas to the respective unit fuel cells in the fuel cell stack. This structure is described as a ninth embodiment. The shift catalyst used in the eighth embodiment may also be used as the shift catalyst of the ninth embodiment. This embodiment, however, does not require the balance of the steam reforming reaction with the shift reaction. Any catalyst having the sufficient activity of accelerating the shift reaction is thus applicable to the shift catalyst of this embodiment.

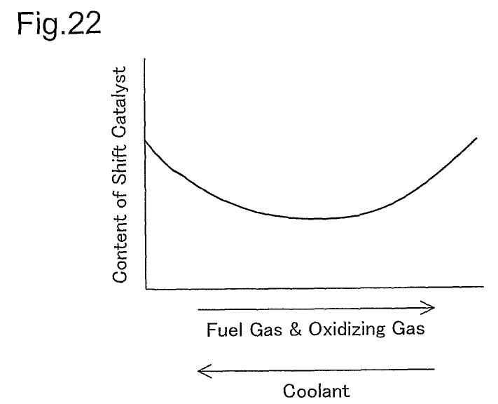

FIG. 22 shows a variation in content of the shift catalyst supported on the surface of the gas separator that defines the fuel gas conduits in each unit cell in the fuel cell stack of this embodiment. Like FIG. 4(A), the graph of FIG. 22 is given on the assumption of the temperature distribution on the unit cell plane shown in FIG. 3 in the absence of the temperature distribution equalizing mechanism with the fuel gas, the oxidizing gas, and the coolant flowed in the same directions as those of the first embodiment. As shown in FIG. 22, the content of the shift catalyst decreases in a potentially higher temperature area and increases in a potentially lower temperature area according to the temperature distribution shown in FIG. 3.

In the structure of this embodiment, the content of the shift catalyst is increased in the potentially lower temperature area. This drives the exothermic shift reaction to accelerate a temperature rise in the lower temperature area and thus advantageously equalizes the temperature distribution on the unit cell plane. The temperature distribution equalizing mechanism with a variation in content of the shift catalyst may be modified in various ways. For example, the content of the shift catalyst supported on the gas separator may be varied stepwise. In another example, the shift catalyst supported on the gas separators may be replaced by catalyst layers of the shift catalyst provided separately from the unit cells. The content of the shift catalyst may be varied according to the position of the laminate in the stack structure of fuel cells.

### F. Modifications

The embodiments and various examples discussed above are to be considered in all aspects as illustrative and not restrictive. There may be many modifications, changes, and alterations without departing from the scope or spirit of the main characteristics of the present invention. Some examples of possible modification are given below.

(1) In the structures of the embodiments discussed above, the electrolyte layer 21 is formed directly on the hydrogen permeable metal layer. In one modified structure, another catalyst layer of a noble metal or a noble metal alloy may be formed between the hydrogen permeable metal layer and the electrolyte layer 21 according to the requirements. A gas permeable member having electrical conductivity may further be formed between the hydrogen permeable metal layer and the gas separator 27. For example, the hydrogen permeable metal layer may be formed on a ceramic base member. In this modified structure, the ceramic base member is located between the hydrogen permeable metal layer and the gas separator 27.

(2) In the unit fuel cell 20 of the embodiment shown in FIG. 1, the hydrogen permeable metal layer 22 formed on the electrolyte layer 21 functions as the anode structure. The anode structure and the cathode structure may be inverted. A hydrogen permeable metal layer is formed on one face of the electrolyte layer 21 to function as the cathode structure, whereas an anode and a catalyst layer similar to the cathode 25 and the catalyst layer 24 are formed on the other face of the electrolyte layer 21. A catalyst layer may further be formed between the electrolyte layer 21 and the hydrogen permeable metal layer of the cathode structure. When the structure of the first embodiment is applied to this modified fuel cell, the content of the catalyst in at least one of the catalyst layer on the cathode structure and the catalyst layer on the anode structure is varied according to the position on the catalyst layer. The structure of varying the surface area of the electrode and the structure of varying the thickness of the hydrogen permeable metal layer are also applicable to this modified fuel cell.

In another modified example, the fuel cell may include multiple electrolyte layers and/or multiple hydrogen permeable metal layers. Similar effects are achieved in any such fuel cells having the multiple hydrogen permeable metal layers formed on the respective planes of the multiple electrolyte layers by providing the temperature distribution equalizing mechanism, for example, the catalyst layer having a varying content of the catalyst, the electrode having a varying surface area, and the hydrogen permeable metal layer having a varying thickness.

(3) The technique of the invention is not restricted to the polymer electrolyte fuel cells but may be applied to any fuel cells including a proton conductive electrolyte layer and a hydrogen permeable metal layer in contact formed on the plane of the electrolyte layer, for example, proton-exchange membrane fuel cells. In the proton-exchange membrane fuel cells, dense hydrogen permeable metal layers are formed on both faces of a solid polymer membrane to hold the water content of the solid polymer membrane. This structure attains the higher operating temperature, compared with the conventional structure of the proton-exchange membrane fuel cells. The solid polymer membrane may be replaced by an electrolyte layer of a hydrated ceramic, glass, or alumina membrane, for example, a hydrated heteropoly acid or β-alumina membrane. The technique of the invention is also applicable to the fuel cell of this structure to provide a temperature distribution equalizing mechanism and accordingly achieve the similar effects.

1. A fuel cell having a hydrogen permeable metal layer that is formed on a plane of an electrolyte layer that has proton conductivity and includes a hydrogen permeable metal, said fuel cell comprising:
a temperature distribution equalizing portion to equalize an uneven temperature distribution in said fuel cell, wherein the uneven temperature distribution is caused by either or both of operating conditions of said fuel cell and surroundings of said fuel cell.

2. A fuel cell in accordance with claim 1, wherein the temperature distribution equalizing portion comprises a shift catalyst portion, which is formed to be in contact with an anode inside said fuel cell and contains a shift catalyst of accelerating a shift reaction to produce hydrogen and carbon dioxide from carbon monoxide and steam, and
the shift catalyst portion receives a supply of a reformed gas containing hydrogen, carbon monoxide, and steam and has a greater content of the shift catalyst in a specific region corresponding to a lower temperature area, which has a lower temperature than a remaining area due to either or both of the operating conditions of said fuel cell and the surroundings of said fuel cell, than a content of the shift catalyst in a residual region corresponding to the remaining area.

3. A fuel cell in accordance with claim 1, wherein the operating conditions of said fuel cell include a temperature and a flow direction of a fluid supplied to said fuel cell.

4. A fuel cell in accordance with claim 1, wherein the temperature distribution equalizing portion controls heat generation in a higher temperature area having a higher temperature than a residual area, due to either or both of the operating conditions of said fuel cell and the surroundings of said fuel cell.

5. A fuel cell in accordance with claim 4, wherein the temperature distribution equalizing portion suppresses an electrochemical reaction in the higher temperature area.

6. A fuel cell in accordance with claim 5, wherein the temperature distribution equalizing portion comprises a catalyst layer that contains a catalyst of accelerating the electrochemical reaction and is formed on an electrode of said fuel cell to have a less content of the catalyst in a specific region corresponding to the higher temperature area than a content of the catalyst in a residual region corresponding to the residual area.

7. A fuel cell in accordance with claim 5, wherein the temperature distribution equalizing portion comprises an electrode that is a thin metal membrane having the electrochemical reaction and is designed to have a smaller surface area in a specific region corresponding to the higher temperature area.

8. A fuel cell in accordance with claim 7, wherein the electrode is the hydrogen permeable metal layer.

9. A fuel cell in accordance with claim 5, wherein the temperature distribution equalizing portion comprises the hydrogen permeable metal layer that is designed to have a greater thickness in a specific region corresponding to the higher temperature area.

10. A fuel cell in accordance with claim 1, wherein a reformed gas prepared by reforming a hydrocarbon fuel is used as a fuel gas supplied to an anode of said fuel cell.

11. A fuel cell in accordance with claim 4, wherein the temperature distribution equalizing portion comprises a reforming catalyst portion, which is formed to be in contact with an anode inside said fuel cell and contains a reforming catalyst of accelerating a reforming reaction to produce hydrogen from a hydrocarbon fuel, and
the reforming catalyst portion receives supplies of the hydrocarbon fuel and steam and has a greater content of the reforming catalyst in a specific region corresponding to the higher temperature area than a content of the reforming catalyst in a residual region corresponding to the residual area.

12. A fuel cell in accordance with claim 1, wherein the temperature distribution equalizing portion is provided to deal with an uneven temperature distribution on an identical plane of said fuel cell as a unit cell of a fuel cell stack, which is caused by either or both of the operating conditions of said fuel cell and the surroundings of said fuel cell.

13. A fuel cell in accordance with claim 1, wherein a number of said fuel cells as unit cells are laminated to form a fuel cell stack, and
the temperature distribution equalizing portion is provided to deal with a total uneven temperature distribution in the whole fuel cell stack, which is caused by either or both of the operating conditions of said fuel cells and the surroundings of said fuel cells.

14. A fuel cell device comprising a fuel cell having a hydrogen permeable metal layer that is formed on a plane of an electrolyte layer that has proton conductivity and includes a hydrogen permeable metal, said fuel cell device comprising:
a temperature distribution equalizing portion to control an uneven temperature distribution in said fuel cells, due to temperature and flow direction of a reactive gas supplied to said fuel cells to be subjected to an electrochemical reaction,
the temperature distribution equalizing portion comprising:
a first flow path and a second flow path to supply and discharge the reactive gas into and from said fuel cells;
a first switchover element that is provided in the first flow path to make a switchover between a gas intake state of allowing the reactive gas to be fed from a conduit connecting with the first flow path and to be introduced into said fuel cells and a gas discharge state of connecting the first flow path with outside to discharge the reactive gas flowed through said fuel cells to the outside; and
a second switchover element that is provided in the second flow path to make a switchover between the gas intake state of allowing the reactive gas to be fed from a conduit connecting with the second flow path and to be introduced into said fuel cells and the gas discharge state of connecting the second flow path with the outside to discharge the reactive gas flowed through said fuel cells to the outside,
wherein the first switchover element and the second switchover element are controlled to regulate the flow direction of the reactive gas passing through said fuel cells.

15. A fuel cell device comprising a fuel cell having a hydrogen permeable metal layer that is formed on a plane of an electrolyte layer that has proton conductivity and includes a hydrogen permeable metal, said fuel cell device comprising:
a temperature distribution equalizing portion to control an uneven temperature distribution in said fuel cells, due to either or both of temperature and flow direction of a reactive gas supplied to said fuel cells to be subjected to an electrochemical reaction and surroundings of said fuel cells,
the temperature distribution equalizing portion comprising:
a reactive gas circulation module that recirculates at least part of a reactive gas exhaust, which is the reactive gas flowed through and discharged from said fuel cells, to the flow of the reactive gas; and
a reactive gas temperature decreasing module that decreases temperature of the reactive gas exhaust, prior to recirculation of the reactive gas exhaust to the flow of the reactive gas.
